(19) United States
(12) Patent Application Publication
(10) Pub. No.: US 2012/0285898 A1
(43) Pub. Date: Nov. 15, 2012

(54) Dispersion of Oil Using Artificially Generated Waves

(76) Inventor: Timothy J. Nedwed, Houston, TX (US)

(21) Appl. No.: 13/514,753

(22) PCT Filed: Dec. 20, 2010
(86) PCT No.: PCT/US10/61307

§ 371 Date: Jun. 8, 2012

Related U.S. Application Data
(60) Provisional application No. 61/301,073, filed on Feb. 3, 2010.

(51) Int. Cl. E02B 15/10; C02F 1/68

(52) U.S. Cl. 210/747.6

(57) ABSTRACT

A method for dispersing oil from an oil spill in a marine environment, in a bay, a sea or ocean in an Arctic region The method generally comprises identifying an oil spill in proximity to an ice field, and further locating an intervention vessel in proximity to the ice field, the intervention vessel having a water-agitating mechanism The method includes actuating the water-agitating mechanism while the intervention vessel is in a substantially stationary location, serving to propagate artificially generated waves into the ice field The method includes continuing to operate the water-agitating mechanism so as to fracture the at least one floating ice mass into smaller ice pieces The method further comprises applying a chemical dispersant to the oil spill, while further operating the water-agitating mechanism, enhancing wave energy within the oil spill, thereby causing oil to disperse within the marine environment

### CROSS-REFERENCE TO RELATED APPLICATION

This application claims the priority benefit of U.S. Provisional Patent Application 61/301,073 filed 3 Feb. 2010 entitled DISPERSION OF OIL USING ARTIFICIALLY GENERATED WAVES, the entirety of which is incorporated by reference herein.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

1. Field of the Invention

The present invention relates to the field of offshore operations in Arctic conditions. More specifically, the present invention relates to the dispersion of oil from an oil spill within a marine environment having one or more floating ice masses.

2. Discussion of Technology

As the world's demand for fossil fuels increases, energy companies find themselves pursuing hydrocarbon resources in more remote areas of the world. Such pursuits sometimes take place in harsh, offshore conditions such as those found in the North Sea. In recent years, drilling and production activities have been commenced in Arctic regions. Such areas include the Sea of Okhotsk at Sakhalin Island, as well as the U.S. and Canadian Beaufort Seas.

Because of the cold ambient temperatures, marine bodies in Arctic areas are frozen over during much of the year. Therefore, exploration and production operations in Arctic areas primarily take place in the summer months. Even during summer months (and the weeks immediately before and after when operations may be extended), the waters are prone to experiencing floating ice masses. Floating ice masses create hazards for equipment, support vessels, and personnel.

In connection with offshore exploration and production activities, and also in connection with transoceanic transportation of oil or gas, incidences of oil spills have taken place. When an oil spill takes place, the operator will want to move as quickly as possible to contain, remove, burn, or disperse the oil. Different processes may be undertaken. In one process, the operator may employ booms to contain the spread of the oil. For example, booms may be used to limit the approach of oil towards beaches and commercial fishing areas. Alternatively or in addition, the operator may employ a skimming operation. In a skimming operation, the oil film created at the surface of the water is removed. Skimming operations typically involve the use of a barge or vessel along with means for capturing oil from the surface of the water and disposing of it in an environmentally responsible manner.

As an alternative to or in connection with a booming and skimming operation, the operator may apply a sorbent material to the oil spill. The sorbent material is an inert and insoluble material that is spread onto the oil spill. The sorbent is used to absorb and/or adsorb oil from the surface of the body of water.

The sorbent material may be an organic material. An example of an organic sorbent used for adsorbing and/or absorbing oil from a body of water is peanut hulls. The peanut hulls may be combined with crushed raw peanut kernels to create a hydrophobic/oleophilic protective film around the peanut hulls. Other organic sorbent products that have been proposed include peat moss, straw, and chicken or duck feathers.

Still other organic sorbent materials include cellulosic or fibrous materials such as raw cotton, granulated cork, corn cobs, cotton hulls, rice hulls, saw dust, and wood chips.

The sorbent material may alternatively be an inorganic material, such as a mineral compound. Examples of sorbent mineral compounds include volcanic ash or perlite, vermiculite or zeolite. Inorganic polymer materials have also been proposed.

As another alternative to booming and skimming, or in addition, the operator may ignite and burn the oil in place. As yet another alternative to a booming and skimming operation, or in addition, the operator may apply a chemical dispersant. A chemical dispersant acts to break up oil spilled on a marine surface and disperse it a small oil droplets into the salt water environment of the marine body.

Examples of chemical dispersants are presented in U.S. Pat. No. 5,728,320, issued to Exxon Research and Engineering Company in 1998. This patent discloses a dispersant formulation which contains a mixture of a sorbitan monoester of an aliphatic monocarboxylic acid, a polyoxyethylene adduct of a sorbitan monoester of an aliphatic monocarboxylic acid, an alkali metal salt of a dialkyl sulfosuccinate, a polyoxyethylene adduct of a sorbitan triester or a sorbitol hexaester of an aliphatic monocarboxylic acid. In addition, the dispersant includes a solvent comprising at least one of a propylene glycol ether, ethylene glycol ether, water, alcohol, glycol, and a paraffinic hydrocarbon.

U.S. Pat. No. 4,560,482, issued to Exxon Research and Engineering Company earlier in 1985, discloses a different dispersant composition. This dispersant composition is designed for treating heavier oils having viscosities of from 1,000 to 10,000 cp in water. In one embodiment, the dispersant comprises a non-ionic surfactant, a polymeric agent and a petroleum oil in a ratio whereby the composition has a sticky gel-like consistency and a viscosity of at least 10% of the viscosity of the oil to be dispersed. The polymeric agent is selected from the group consisting of polyisobutylene, ethylene-propylene copolymers, polydimethyl siloxane, polypropylene oxide, cis polyisoprene, cis polybutadiene and polystyrene.

The use of any of the above techniques for removing oil following an oil spill may be problematic in Arctic regions. While Applicant is unaware of any notable offshore oil spills that have taken place in an Arctic marine body; Applicant believes that floating ice masses could interfere with remediation efforts that might otherwise be conducted. For example, an oil spill residing in the leads between floating ice masses may not be collectible in some conditions using booming and skimming techniques. Likewise, an oil spill residing under a floating ice mass or on a floating ice mass cannot be effectively treated using a chemical dispersant, as the chemical dispersant requires both access to the oil and wave energy from the marine body for effectively breaking up the oil slick. In addition, while oil residing between floating ice masses may be accessible for dispersant application, the ice masses may dampen the natural wave energy needed to effectively break up the oil slick.

Therefore, an improved method is needed for remediating an oil spill in an Arctic environment. Further, an improved method is needed for facilitating the break-up of an oil spill and dispersing the oil in a marine environment in the presence of at least one floating ice mass. A need further exists for applying wave energy to an oil spill residing in an ice field to facilitate hydrocarbon molecule dispersion.

### SUMMARY OF THE INVENTION

The methods described herein have various benefits for the support of oil and gas exploration and production activities in Arctic regions. First, a method is provided for dispersing oil from an oil spill in a marine environment. The marine environment comprises a body of water, and a surface of the body of water. The marine environment may be, for example, a bay, a sea or an ocean in the Arctic region of the earth.

The marine environment also has an ice field. At least one floating ice mass resides within the ice field. The ice mass floats on the surface of the body of water.

The method, in one embodiment, includes the step of identifying an oil spill in proximity to the at least one ice mass. The oil spill may have been caused in connection with drilling activities in the ice field. Alternatively, the oil spill may have been caused in connection with production activities or fluid separation processes. Alternatively still, the oil spill may have been caused from hydrocarbon transportation activities, either from a leak or rupture in a flow line or other piping, or from a leak or rupture in the hull or holding tank or piping on a vessel.

The method also includes locating an intervention vessel in proximity to the ice field. The intervention vessel may be, for example, a ship-shaped vessel having a deck and a hull. Preferably, the intervention vessel is a ship-shaped vessel equipped with ice-breaking capability. As an alternative, the intervention vessel may be a non-ship-shaped platform. The platform is preferably a floating platform. The intervention vessel is preferably maintained on location through either a dynamic positioning system or by mooring.

The intervention vessel has a water-agitating mechanism carried thereon. Various types of water-agitating mechanisms may be employed. For example, the water-agitating mechanism may comprise a gyroscopic system attached to the hull of the intervention vessel. The gyroscopic system may comprise a large spinning mass, a controller, and at least one gear for moving the large spinning mass so as to cause forced precession. The controller reciprocates the large spinning mass according to a specified frequency and amplitude. The large spinning mass is reciprocated in a direction to cause the intervention vessel to pitch, to roll, or combinations thereof. This movement of the intervention vessel, in turn, creates ice-breaking waves and induces motion in broken ice pieces.

In another embodiment, the water-agitating mechanism comprises a plurality of air guns. The air guns are disposed below the surface of the marine environment in the body of water. The plurality of air guns may be fired substantially simultaneously at a frequency of about two seconds to five seconds (0.5 Hz to 0.25 Hz).

In another embodiment, the water-agitating mechanism comprises a plurality of paddles. The paddles rotate through the surface of the marine environment and into the body of water. The plurality of paddles may rotate substantially simultaneously at a frequency of about three to five seconds (0.33 Hz to 0.2 Hz).

In another embodiment, the water-agitating mechanism comprises at least one pair of offsetting propulsion motors. The propulsion motors operate below the surface of the marine environment and in the body of water. In one aspect, the at least one pair of offsetting propulsion motors are intermittently started and stopped in cycles to create waves having well-defined peaks and troughs. The cycles may be, for example, every two to ten seconds (0.5 Hz to 0.1 Hz).

In still another embodiment, the water-agitating mechanism comprises a plurality of plungers that reciprocate in the body of water. In one aspect, the plurality of plungers reciprocate substantially simultaneously.

In one arrangement, the plurality of plungers may reciprocate according to a vertical stroke that is about 10 to 34 feet. In this instance, the frequency of the strokes may be about every three to ten seconds (0.33 Hz to 0.1 Hz). Here, the top of the stroke is at or above the surface of the body of water, while the bottom of the stroke is below the surface of the body of water.

In another arrangement, the plurality of plungers may reciprocate according to a stroke that is about 1 to 5 feet. This is a much shorter stroke such that the plunger is in the nature of a resonance vibrator. In this instance, the frequency of the strokes is about 0.1 to 2.0 seconds (10.0 Hz to 0.5 Hz). Here, both the end of each stroke is below the surface of the body of water.

The method for dispersing oil from an oil spill in a marine environment also includes actuating the water-agitating mechanism. In this way the water-agitating mechanism propagates artificially generated waves into the ice field. During actuation and operation, the intervention vessel is in a substantially stationary location.

The method next includes continuing to operate the water-agitating mechanism in order to propagate additional artificially generated waves. The waves travel towards a leading edge of the at least one floating ice mass. In one aspect, the artificially generated waves have an amplitude of about two feet to five feet. The creation of artificially-generated waves serves to fracture the at least one floating ice mass into small ice pieces.

The small ice pieces float in the marine environment. Some of the small pieces may float towards the intervention vessel. However, as the water-agitating mechanism continues to operate, the smaller floating ice pieces will be diverted around the intervention vessel.

The method further includes applying a chemical dispersant to the oil spill. The chemical dispersant may be applied before, during, or after substantial break-up of the at least one floating ice mass. The chemical dispersant serves to help break up the oil.

The method also comprises continuing to further operate the water-agitating mechanism. This serves to further break up ice in the ice field, and continue to supply wave energy within the oil spill. This enables oil within the oil spill to disperse within the marine environment. Thus, dispersion takes place through the novel combination of chemical dispersant and artificially-generated marine wave energy.

In one embodiment of the method, the at least one floating ice mass comprises a plurality of ice masses separated by leads. The oil spill is at least partially located in the leads. In this embodiment, applying a chemical dispersant to the oil spill comprises applying the chemical dispersant to oil located in the leads.

In another embodiment of the method, the oil spill is at least partially located below the at least one floating ice mass and along the surface of the body of water. In this instance, the method includes fracturing the at least one floating ice mass into smaller ice pieces. This at least partially exposes oil in the oil spill. The step of applying a chemical dispersant to the oil spill then comprises applying the chemical dispersant to the exposed oil.

### BRIEF DESCRIPTION OF THE DRAWINGS

So that the present inventions can be better understood, certain illustrations and flow charts are appended hereto. It is to be noted, however, that the drawings illustrate only selected embodiments of the inventions and are therefore not to be considered limiting of scope, for the inventions may admit to other equally effective embodiments and applications.

FIG. 1A is an aerial, schematic view of a marine ice field wherein hydrocarbon recovery operations are taking place. An oil spill has taken place in the ice field. An intervention vessel having a water-agitating mechanism is provided in the marine ice field to break up ice masses.

FIG. 1B is an aerial, schematic view of the marine ice field of FIG. 1A. Here, the water-agitating mechanism has begun breaking up the ice mass in the ice field into smaller ice pieces.

FIG. 2A is a cross-sectional view of an intervention vessel having a water-agitating mechanism, in a first embodiment. Here, the water-agitating mechanism is a hydro-gyroscope for inducing motion of the vessel.

FIG. 2B is a plan view the hydro-gyroscopic system of FIG. 2A.

FIG. 2C is a side view of the hydro-gyroscope of FIG. 2A. Here, the gear system for forced precession is seen.

FIG. 3 is an end view of an intervention vessel having a water-agitating mechanism, in a second embodiment. Here, the water-agitating mechanism includes a plurality of pneumatic guns.

FIG. 4 is a cross-sectional view of an intervention vessel having a water-agitating mechanism, in a third embodiment. Here, the water-agitating mechanism includes a plurality of rotating paddles.

FIG. 5 is an end view of an intervention vessel having a water-agitating mechanism, in a fourth embodiment. Here, the water-agitating mechanism includes a pair of offsetting propulsion motors.

FIGS. 6A and 6B are cross-sectional views of an intervention vessel having a water-agitating mechanism, in a fifth embodiment. Here, the water-agitating mechanism includes at least one plunger, each plunger having long vertical strokes that move the plunger vertically in the water.

FIG. 6A shows the plunger at the top of its stroke at or above the surface of the water.

FIG. 6B shows the plunger at the bottom of its stroke under the surface of the water.

FIG. 7 is a cross-sectional view of an intervention vessel having a water-agitating mechanism, in a sixth embodiment. Here, the water-agitating mechanism is a plunger oscillating with fast, short strokes under the water.

FIG. 8 is a flowchart showing steps for dispersing oil from an oil spill in a marine environment, in one embodiment. The marine environment has at least one floating ice mass.

FIGS. 9A through 9C present illustrative steps for the dispersion of oil into water using a chemical dispersant. A pool of oil, or “oil slick,” is seen floating on the surface of a body of water, or marine body.

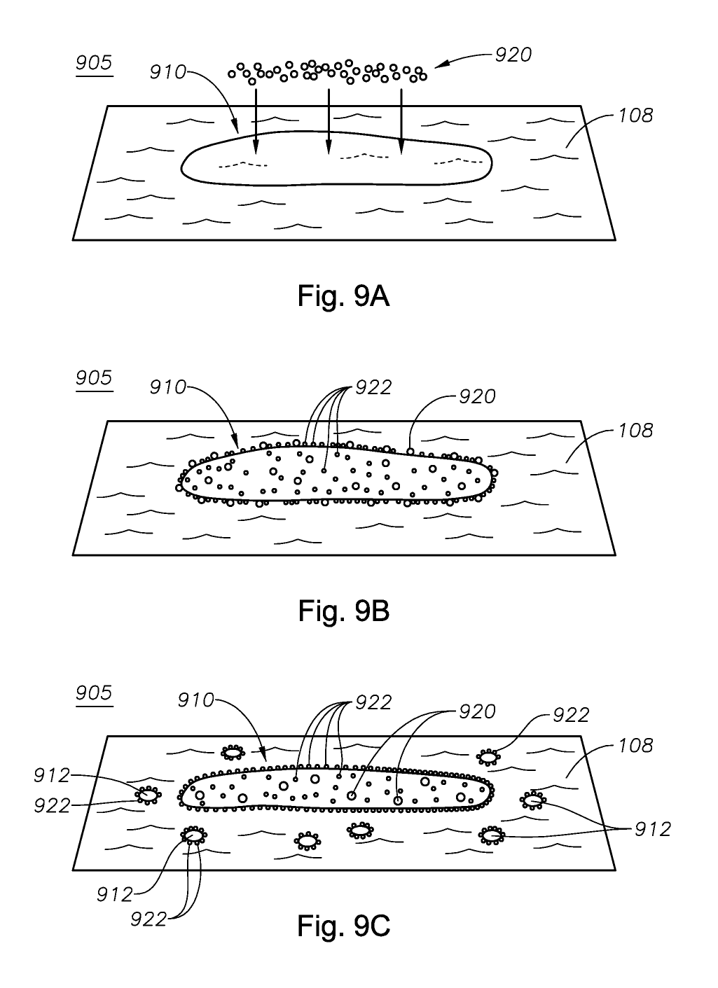

In FIG. 9A, a liquid chemical dispersant is being applied to the oil.

In FIG. 9B, surfactants within the liquid chemical dispersant penetrate the oil slick and begin to locate at the oil/water and the oil/air interfaces.

In FIG. 9C, the oil slick begins to break up into droplets. The oil droplets are being dispersed into the marine body.

### DETAILED DESCRIPTION OF CERTAIN EMBODIMENTS

### Definitions

As used herein, the term “hydrocarbon” refers to an organic compound that includes primarily, if not exclusively, the elements hydrogen and carbon. Hydrocarbons may also include other elements, such as, but not limited to, halogens, metallic elements, nitrogen, oxygen, and/or sulfur. Hydrocarbons generally fall into two classes: aliphatic, or straight chain hydrocarbons, and cyclic, or closed ring hydrocarbons, including cyclic terpenes. Examples of hydrocarbon-containing materials include any form of natural gas, oil, coal, and bitumen that can be used as a fuel or upgraded into a fuel.

As used herein, the term “hydrocarbon fluids” refers to a hydrocarbon or mixtures of hydrocarbons that are gases or liquids. For example, hydrocarbon fluids may include a hydrocarbon or mixtures of hydrocarbons that are gases or liquids at formation conditions, at processing conditions or at ambient conditions (15° C. and 1 atm pressure). Hydrocarbon fluids may include, for example, oil, natural gas, coalbed methane, shale oil, pyrolysis oil, pyrolysis gas, a pyrolysis product of coal, and other hydrocarbons that are in a gaseous or liquid state.

As used herein, the terms “produced fluids” and “production fluids” refer to liquids and/or gases removed from a subsurface formation, including, for example, an organic-rich rock formation. Produced fluids may include both hydrocarbon fluids and non-hydrocarbon fluids. Production fluids may include, but are not limited to, pyrolyzed shale oil, synthesis gas, a pyrolysis product of coal, carbon dioxide, hydrogen sulfide and water (including steam).

As used herein, the term “fluid” refers to gases, liquids, and combinations of gases and liquids, as well as to combinations of gases and solids, and combinations of liquids and solids.

As used herein, the term “gas” refers to a fluid that is in its vapor phase at 1 atm and 15° C.

As used herein, the term “oil” refers to a hydrocarbon fluid containing primarily a mixture of condensable hydrocarbons.

The term “Arctic” refers to any oceanographic region wherein ice features may form or traverse through and affect marine operations. The term “Arctic,” as used herein, is broad enough to include geographic regions in proximity to both the North Pole and the South Pole.

The term “marine environment” refers to any offshore location. The offshore location may be in shallow waters or in deep waters. The marine environment may be an ocean body, a bay, a large lake, an estuary, a sea, or a channel.

The term “ice mass” means a floating and moving mass of ice, floe ice, or ice berg. The term also encompasses pressure ridges of ice within ice sheets.

### DESCRIPTION OF SELECTED SPECIFIC EMBODIMENTS

The inventions are described herein in connection with certain specific embodiments. However, to the extent that the following detailed description is specific to a particular embodiment or a particular use, such is intended to be illustrative only and is not to be construed as limiting the scope of the inventions.

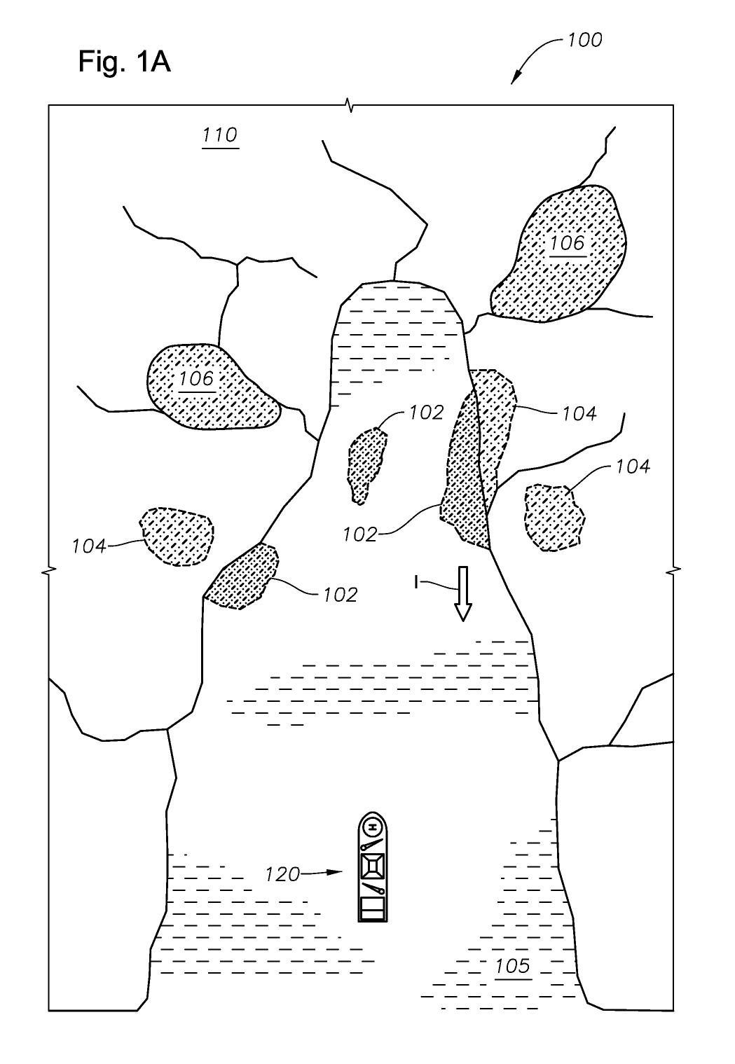

FIG. 1A is a schematic view of a marine ice field 100. The ice field 100 resides over a large marine body 105. The marine body 105 is preferably a salt water body in the Arctic region of the earth. Examples of such marine areas include the U.S. Beaufort Sea, the Canadian Beaufort Sea, the Arctic Ocean, Baffin Bay, Hudson Bay, and the Sea of Okhotsk at Sakhalin Island.

The ice field 100 contains one or more large ice masses. In the arrangement of FIG. 1A, a single floating ice mass is provided at 110. The ice mass 110 may be moving in a direction as indicated by arrow “I.”

The marine ice field 100 is undergoing hydrocarbon development activities. In FIG. 1A, a hydrocarbon development platform 120 is provided as part of the hydrocarbon development activities. In the arrangement of FIG. 1A, the hydrocarbon development platform 120 is a drill ship. The drill ship 120 operates to drill one or more wellbores through subsurface strata. The drill ship 120 is then used to complete the wellbores in such as way as to safely and efficiently produce valuable hydrocarbons to the earth surface.

While a drill ship 120 is shown in FIG. 1A, it is understood that the hydrocarbon development platform 120 may be another type of platform. For example, the hydrocarbon development platform 120 may be a production platform, a workover platform, a floating production, storage and offloading (“FPSO”) vessel, an offshore workboat, a catenary anchor leg mooring (“CALM”) buoy, or an oceanographic survey vessel. Other types of vessels include a construction vessel as may be used to install subsea equipment or to lay pipe, a subsea cable installation vessel, a diver support vessel, an oil spill response vessel, or a submarine rescue vessel.

As a result of hydrocarbon development activities in the ice field 100, an oil spill has taken place. The oil spill has produced patches of oil in the marine body 105, indicated at 102. In some instances, the oil may reside on top of a portion of the ice mass 110. Such illustrative oil patches are indicated at 104. In other instances, the oil may reside under the ice mass 110. Alternatively or in addition, the oil may reside between broken portions of the ice mass 110, referred to as “leads.” Leads having oil residing therein are shown at 106.

As discussed above, known techniques for removing oil following an oil spill may be problematic in Arctic regions. Applicant is concerned that floating ice masses can interfere with remediation efforts that might otherwise be conducted. Ice can either substantially cover the ice surface, which will require that the ice be broken, or the presence of existing broken ice floes can dampen the ocean's natural wave energy. In either instance, generating artificial waves can allow dispersants to work in breaking up the oil. Therefore, it is proposed herein to break up an ice mass in which an oil spill has taken place by using artificially-generated waves. Further, it is proposed herein to disperse oil from the oil spill by applying a chemical dispersant, and then enhancing the dispersion by applying the wave energy generated from the artificially-generated waves.

FIG. 1B presents another schematic view of the marine ice field 100 of FIG. 1A. Patches of oil are again seen at 102, 104, and 106. To break up the ice mass 110 from the ice field 100 and to disperse the oil during or following application of chemical dispersants, the ice mass 110 is being broken into smaller ice pieces using artificially-generated waves 135.

In FIG. 1B, an intervention vessel 130 has been moved into the ice field 100. The intervention vessel 130 has been placed between the floating ice mass 110 and the hydrocarbon development platform 120. This not only serves to break up the ice mass 110, but beneficially clears the ice mass 110 from impacting the hydrocarbon development platform 120. Of course, the present inventions do not require the presence of a hydrocarbon development platform or this beneficial clearing function.

The intervention vessel 130 is preferably a ship-shaped vessel capable of self-propulsion by means of propellers and propeller shafts. In addition, the ice breaking vessel 130 is preferably equipped with integral ice-breaking capability. This means that the intervention vessel 130 preferably has a strengthened hull, a rounded, ice-clearing profile or shape, and engine power to push over ice masses within ice-covered waters. To pass through ice-covered waters, the intervention vessel 130 uses momentum and power to drive its bow up onto an ice mass. The ice is incrementally broken under the weight of the ship. Because a buildup of broken ice in front of the intervention vessel 130 can slow it down more than the breaking of ice itself, the speed of the ship is increased by having a specially designed hull to direct the broken ice around or under the vessel 130.

While it is preferred that the intervention vessel 130 be a ship-shaped ice-breaking ship, it is within the scope of the inventions herein that the intervention vessel be a floating platform moored to the ocean bottom. In this instance, the intervention vessel 130 is towed into position adjacent the ice mass 110.

In either arrangement, the intervention vessel 130 is equipped with a water-agitating mechanism. The water-agitating mechanism resides within the intervention vessel 130 or is supported by the intervention vessel 130 within the marine body 105. The water-agitating mechanism generates artificial waves that propagate through the marine body 105 and impact the large ice mass 110.

In FIG. 1B, action of the water-agitating mechanism creates wakes 132. In addition, the water-agitating mechanism creates waves 135. The waves 135 propagate through the ice mass 110, causing it to oscillate upon the surface of the marine body 105.

It is known that wave action can break up ice masses. Some research has been conducted by others to study the effects of waves in order to both understand ice morphology at the ice edge and to understand wake impacts on the ice edge of icebreaker-maintained shipping lanes. Two such studies are reported in C. Fox. and V. A. Squire, “Strain in Shore Fast Ice Due to Incoming Waves and Swell,” Journal of Geophysical Research, Vol. 96, No. C3, pp. 4531-4547 (Mar. 15, 1991); and D. Carter, Y. Ouellet, and P. Pay, “Fracture of a Solid Ice Cover by Wind-induced or Ship-generated Waves,” Proceedings of the 6^{th} International Conference on Port and Ocean Engineering under Arctic Conditions, Quebec, Canada, pp. 843-845 (1981).

Through research and numerical modeling, Fox and Squire found that “for 1 m [thick] ice, waves in the broad 5- to 10-second [frequency] range can break ice if their amplitude is 90 mm or more.” Fox and Squire further reported that “a 15-second wave would need to have an amplitude of 280 mm[,] and a 20-second wave would need an amplitude of 630 mm.” Assuming the Fox and Squire analysis is of the correct magnitude, ice floating in an Arctic production area can be fractured using waves artificially generated at the proper frequency.

Ice management systems have been considered in connection with oil and gas exploration, development, and production operations in Arctic regions. Ice management systems are desirable for reducing the ice impact loads on floating equipment. One method of ice management involves the use of ice breaking vessels to actively break large ice floes into smaller pieces. Of course, technology is already in use for mechanically breaking ice by direct contact with a ship hull. Breaking ice is generally not a case of cutting through the ice by forcing the vessel into an ice mass; rather, ice breaking occurs by the ice-strengthened ship riding up and over an ice mass, with the weight of the ship then breaking the ice. This technology is widely practiced outside the context of oil and gas exploration and production activities, such as for keeping shipping lanes open.

In the context of hydrocarbon development activities within an Arctic region, an ice breaking vessel has been considered for breaking large ice masses into smaller ice pieces. The smaller ice pieces may then be moved out of the path of floating equipment. Where the floating ice pieces are very small, such pieces will have only a small impact load that can readily be handled by floating equipment. Alternatively, they may be pushed aside using a tug boat.

Another technique for managing ice floes involves the use of dual ice breakers. Applicant is aware of an arctic coring expedition that was conducted near the North Pole in the summer of 2004. This was reported by K. Moran, J. Backman and J. W. Farrell, “Deepwater Drilling in the Arctic Ocean's Permanent Sea Ice,” Proceedings of the Integrated Ocean Drilling Program, Volume 302, 2006). For this operation, two icebreakers were stationed updrift of a stationary seafloor coring vessel. The first ice breaker reportedly traveled in a circular pattern to reduce the size of large ice floes to pieces that were a maximum of 100 to 200 meters wide. The second icebreaker then broke the large ice pieces to produce smaller ice masses that were up to 20 meters wide. In this program, the coring vessel was able to maintain location for as long as nine consecutive days despite the presence of the broken ice pieces.

The use of active ice breaking vessels to protect floating equipment in the Arctic has several drawbacks. First, it requires maintaining at least one very robust ice breaking vessel, and preferably two. Second, where a second ice breaking vessel is used, the second ice breaking vessel may be unrealistically required to make tight circles or to maintain a position in direct coordination with the first ice breaker. Third, in the event of an oil spill, the ice breaking vessel would be required to travel through the oil. The present method of using a water-agitating mechanism on a remote ice-breaking vessel offers advantages over the direct use of one or more icebreakers.

In FIG. 1B, it can be seen that waves 135 artificially generated from the intervention vessel 130 have begun to fracture the ice mass 110. First, small ice pieces 112 are formed near the ice edge along the marine body 105. Further, large ice pieces 115 are formed interior from the ice edge. The large ice pieces 115 will be broken into smaller pieces as the waves 135 continue to be generated by the water-agitating mechanism.

In operation, the generation of waves 135 will cause the smaller ice pieces 112 to form and then break off from the ice mass 110. As the smaller ice pieces 112 break away, the larger ice pieces 115 will become the new ice edge. The continued wave action from waves 135 will cause the larger ice pieces 115 (now at the ice edge) to break into new smaller ice pieces 112. The new smaller ice pieces 112 will then break off from the ice mass 110, thus enabling a substantial break-up of the entire ice mass 110 over time. More importantly, oil from the oil spills is exposed to the wave action from the artificially-generated waves 135.

As the smaller ice pieces 112 break away from the ice mass 110, the smaller ice pieces 112 begin to independently float in the marine body 105. This creates small floating ice pieces 114. Action of the waves 135 will not only break the ice mass 110 into smaller fractured ice pieces 115, 112 and small floating ice pieces 114, but will also enhance the effectiveness of the chemical dispersant.

As a result of the wave energy being sent through the ice mass 110 and the resultant ice mass break-up, the oil patches 102, 104, 106 are being dispersed. First, it can be seen that oil patches 102, or “oil slicks,” floating in the marine body 105 are becoming smaller. Further, the oil patches 102 are dispersing through the marine body 105.

Second, the oil patches 104 that were floating on the ice mass 110 are now floating in the marine body 105. In some cases, the oil patches 104 that were floating on the ice mass 110 are now a part of the small ice pieces 112 that have broken off from the ice mass 110. In other instances, the oil on the oil patches 104 is floating on the surface 108 of the marine body, becoming part of oil slicks 106.

Third, the oil patches 106 in the leads are working their way out of the ice mass 110. It can be seen that the oil patches 106 are now much closer to open water. Once the oil patches 106 are in the open water, they will be more fully exposed to the wave energy of the artificially-generated waves 135, and dispersed in the marine body 105 along with oil slicks 102. Stated another way, the action of the waves causes turbulence either by the waves themselves or by the waves causing motion with the ice. In some instances, the turbulence of small floating ice pieces 114 hitting each other is enough to cause dispersion of oil between the ice pieces 114.

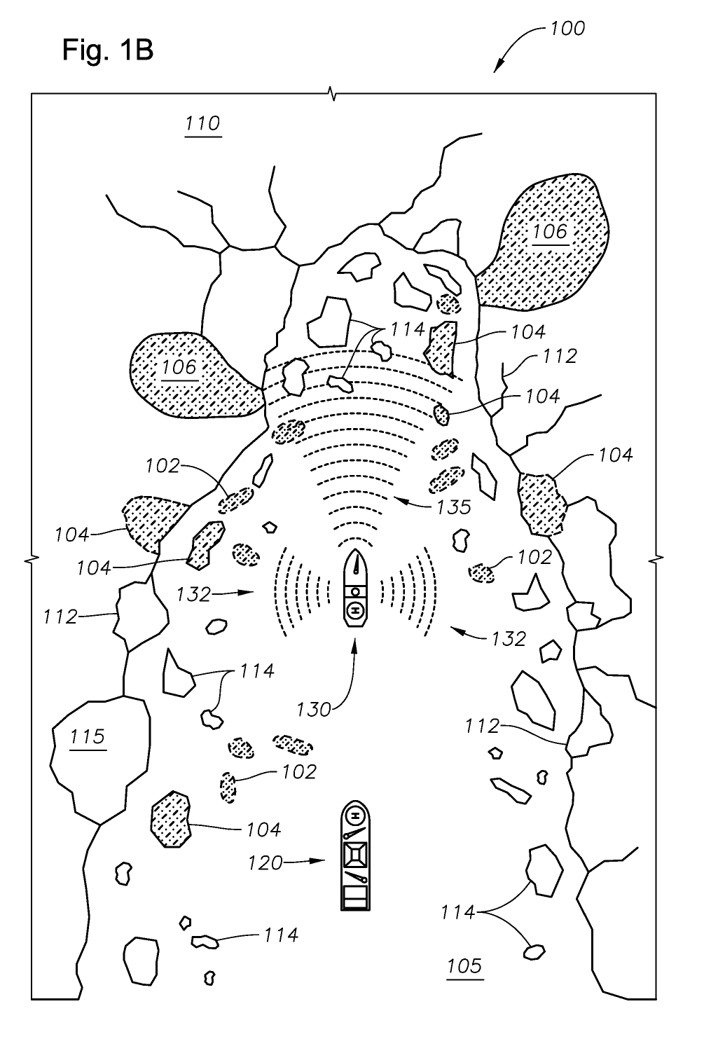

Various methods are offered herein for propagating surface waves 135 to generate wave energy across the marine body 105. These are presented in and discussed in connection with FIGS. 2 through 7, below.

First, FIG. 2A provides a cross-sectional view of an intervention vessel 230 having a water-agitating mechanism, in a first embodiment. The intervention vessel 230 includes a deck 210 and a hull 212. The water-agitating mechanism is shown within the hull 212 of the vessel 230 at 220.

The vessel 230 is representative of the intervention vessel 130 of FIG. 1. In this respect, the vessel 230 is a ship-shaped vessel preferably having ice-breaking capabilities. In addition, the vessel 230 preferably has a large water displacement for generating substantial waves 135 during motion.

In the arrangement of FIG. 2, the water-agitating mechanism 230 is a gryoscopic system. Gyroscopes are commonly used in modern marine structures for sensing a ship's motion and then activating a separate stabilization mechanism. Stabilization increases passenger comfort and safety, reduces wear and tear on equipment, and increases the accuracy of warship artillery.

A gryoscopic system uses angular momentum and precession to counter ship oscillations. A gyroscope mounted with its gimbal axis orthogonal to the major axis of a ship serves to limit rolling motion. Further, a gyroscope mounted with the gimbal axis parallel to the major axis of the ship reduces pitching motion. Larger vessels require a larger gyroscopic system that can provide greater stabilization forces, while smaller vessels may employ a smaller gyroscopic system.

An early gyroscope patent is U.S. Pat. No. 1,150,311, which issued in 1915 to inventor Elmer A. Sperry. The '311 patent was entitled “Ship's Gyroscope.” Mr. Sperry's gyroscope employed a large, solid spinning mass that precessed about gimbal bearings. The gimbal bearings were connected to a frame. The frame, in turn, was operatively connected to the hull of a ship.

Mr. Sperry's gyroscope was utilized by the U.S. Navy as an early gyro-stabilizer system. According to one publication, the gyro was installed aboard a small 700 ton destroyer, and in a submarine. Using the centrifugal motion of the spinning mass, gyrsoscopic forces were transmitted to the hulls of the naval vessels through the gimbal axis. Depending upon the orientation of the gimbal axis, the gyroscopic forces could stabilize a floating vessel either as to pitch or as to roll.

Mr. Sperry's gyroscope was “active” in operation, as opposed to being “passive.” In this respect, the Sperry gyroscope used a small gyroscope that sensed the onset of rolling motion. This small gyroscope was electrically connected to the switch of a motor that actuated a precessional gear mounted on a much larger gyroscope. A small gyroscope is more sensitive to rolling motion at inception than a large gyroscope. By activating the motor connected to the precessional gear of the large gyroscope, the large gyroscope was forced to precess at the moment it was needed. Further the motor can increase or decrease the angular velocity of precession to increase or decrease the stabilizing torque as needed based on the magnitude of the external torque.

Stabilizing torque of a gyroscope is a function of several factors. These include mass of the flywheel, or “rotor,” angular velocity of the rotor, radius of the rotor, and angular velocity of precession of the rotor when subject to an external torque. In order to provide stabilization for a large vessel such as a war ship, Mr. Sperry's ship gyroscope was required to utilize a large metal rotor having a great deal of mass. According to one publication, Mr. Sperry's gyroscope as utilized by the U.S. Navy weighed 5 tons.

In the present application, the gyroscopic system 220 is used not for vessel stabilization, but to actually induce side-to-side motion. The side-to-side motion may be either a rolling motion, a pitching motion, or intermittently a rolling motion and a pitching motion. The purpose is to create waves 135 that hit the ice edge and to create break-up of the ice mass 110. To effectuate the rolling motion and the pitching motion, precession is forced upon a gear motor 255 according to a predetermined frequency and angle.

As seen in FIG. 2A, the gryoscopic system 220 includes frame support members 222. The frame support members 222 are secured to the hull 212 of the vessel 230 at an orientation that is orthogonal to the length (or major axis) of the vessel 230. This allows the hydro-gyroscope 220 to de-stabilize the vessel 230 so that it may roll from side-to-side. If the operator desires to de-stabilize the vessel 230 as to pitch, the frame support members 222 are secured to the hull 212 of the vessel 230 at an orientation that is parallel to the length of the vessel 230.

In one arrangement, a pair of vessel de-stabilizing apparatuses 220 is provided in the hull 212 of the vessel 230, with one being positioned to de-stabilize the vessel 230 as to pitch forces, and the other being positioned to de-stabilize the vessel 230 as to roll forces. In another arrangement, a single gyroscope 220 may be employed, with the gyroscope being rotatable within the hull 212 of the vessel 230. For example, the opposing frame support members 222 could be placed on a circular track and given rotational movability along a horizontal plane. In this way, a single gyroscope 220 (whether active or passive) may be employed to de-stabilize the vessel 230 selectively as to both pitch forces and roll forces.

The manufacture of gyroscopic systems is understandably expensive. In addition, the added weight of the spinning mass of a gyroscope increases the fuel consumption of the vessel 230 when in transit. Therefore, it is preferred that the gyroscopic system 220 be a “hydro-gyroscope,” meaning a gyroscopic device that employs a container that may be selectively filled with sea water, and later emptied. Such a hydro-gyroscope is disclosed in U.S. Pat. No. 7,458,329, entitled “Hydrogryo Ship Stabilizer and Method for Stabilizing a Vessel.”

The illustrative gyroscopic 220 next includes a spinning mass such as liquid container 240. The spinning liquid container has a cylindrical wall 242 that defines an internal chamber 245. The chamber 245 provides an internal flow path in which fluid rotationally travels. Spinning movement of the liquid container 240 creates the gyroscopic forces applied to the hull 212 of the vessel 230.

A means is provided for inducing rotational motion of the liquid within the inner chamber 245 of the container 240. In the embodiment of FIG. 2A, the means is a motor 250. The motor 250 is a mechanical motor, and may be either electrically powered, steam powered, hydraulically powered, or powered by a hydrocarbon fuel. The motor 250 is connected to a shaft 264 and mounted to a gimbal frame 260. This allows the liquid container 240 to precess along the major axis of the vessel 230.

The gyroscopic system 220 also includes gimbal connections 224. The gimbal connections 224 are secured between the opposing frame support members 222. The gimbal connections 224 are connected by a shaft 225 that supports the gimbal frame 260 and that forms a gimbal axis for the liquid container 240. Each of the gimbal connections 224 includes a bearing 224 that provides relative rotational movement between the gimbal frame 260 and the frame support members 222. The frame support members 222, in turn, are secured to the hull 212 of the vessel 230.

The spinning liquid container 240 is provided as part of a controlled gear system 270. In this respect, the gear system 270 is neither passive nor active, but provides precessional forces in response to signals sent by a controller. A controller is seen at 280 in FIG. 2C.

In the arrangement of FIGS. 2A and 2C, the gear system 270 includes a first gear 274 connected to the gimbal axis 225. The first gear 272 turns in response to rotational mechanical force (such as by teeth) provided from a second gear 274. The second gear 274, in turn, is driven by a gear motor 255. Thus, movement by the gear motor 255 forces the gimbal frame 260 to turn, thereby creating precessional forces on the vessel 230.

FIG. 2B is a top view of the gyroscopic system 220 of FIG. 2A. Arrow R indicates the direction of rotation of the liquid container 240. Of course, the container 240 may be urged by the motor 250 to spin in either direction.

Visible in the top view of FIG. 2B is a bearing connector 262. The bearing connector 262 is provided at an interface with the gimbal frame 260 and a rotational shaft 264. The bearing connector 262 allows the liquid container 240 to rotate relative to the gimbal frame 260 around an axis that is essentially vertical to the hull 212 of the vessel 230 when the gyroscopic system 220 is not precessing.

FIG. 2C is a side view of the gyroscopic system 220 of FIG. 2A. Here, the gear system 270 is more clearly seen. The gear system 270 again includes a first gear 272 and a second gear 274. The first gear 272 comprises a first set of teeth 271, while the second gear 274 comprises a second set of teeth 273. The first set of teeth 271 and the second set of teeth 273 are configured and dimensioned to interlock as is known for a gear system.

A controller 280 is provided as part of the gyroscopic system 220. The controller 280 is in electrical communication with the gear motor 255 by wires 282, and sends instructions to the gear motor 255 to turn the second gear 274 clockwise and counter-clockwise in order to provide reciprocating precessional forces to the spinning liquid container 540.

In operation, the illustrative liquid container 240 serves as a hydro-gyro rotor. Preferably, the spinning liquid container 240 is filled with seawater after the intervention vessel 230 has been transported to the desired location in the marine body 105. The container 240 filled with seawater spins about the rotational axis 264 using power from the motor 250. The bearings 262 and shaft 225 provide lateral support for the liquid container 240 relative to the gimbal frame 260, while allowing rotational movement of the liquid container 240. The liquid container 240, the gimbal frame 260, and motor 250 are free to precess on the gimbal axis provided by the shaft 225 and frame connectors 224. For example, when creating rolling motion in the vessel 230, the motor 250 would swing like a pendulum into and out of the page in the view of FIG. 2A.

It can be seen from FIGS. 2A through 2C that a unique water-agitating mechanism 220 is provided. The water-agitating mechanism 220 generates waves 135 through a ship-mounted gyroscope. The gyroscope is preferably a hydro-gyroscope, but may operate through a solid spinning mass. Other arrangements for a hydro-gyroscope are presented in U.S. Pat. No. 7,458,329, mentioned above. The '329 patent is incorporated herein by reference in its entirety. Thus, the gyroscope may be a non-hydro-gyroscope such as a metal-based gyroscope.

The gyroscope that includes a spinning mass such as fluid container 240 undergoes forced precession. The precession takes place at a desired frequency as determined by the controller 280. The forced precession induces rocking or pitching of the vessel 230. This rocking or pitching motion of the vessel 230, in turn, generates a continuous train of waves 135 in the marine body 105. The waves 135 propagate away from the vessel 230 and into the ice mass 110 to induce wave fracture. In this respect, ice break-up is caused by the brittle ice being cantilevered over or spanning across wave troughs.

Another means for artificially generating waves 135 within the marine body 105 involves the use of air guns. Air guns operate by containing compressed gas at high pressure (e.g., 2,000 to 3,000 psia) within a valve chamber. The compressed gas is ordinarily air.

Various types of air guns are commonly used as acoustic sources for marine reflection and refraction surveys. One or more passages is provided in the gun to release the gas from the valve chamber and into a surrounding medium, that is, sea water. The passage remains closed while the pressure (as from a compressor on a surface vessel) is built up in the chamber. The passage is opened when the gun is “fired”, allowing the compressed gas to expand out of the chamber and into the surrounding medium.

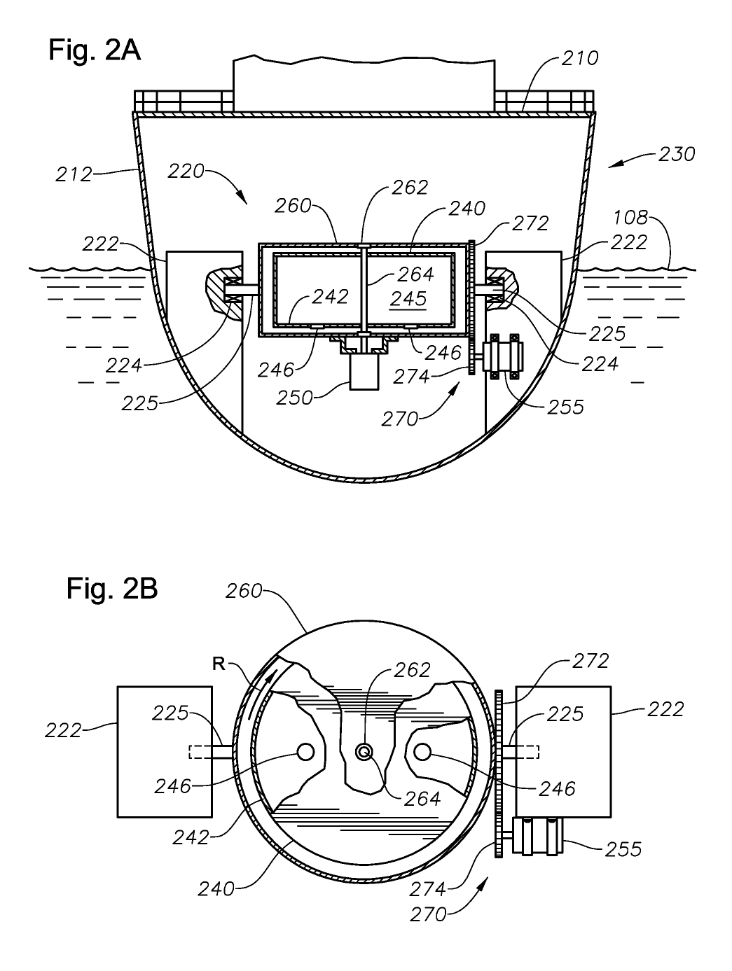

FIG. 3 is a side view of an intervention vessel 330 using a water-agitating mechanism 320 in a second embodiment. The intervention vessel 330 includes a deck 310 and a hull 312. The vessel 330 is representative of the intervention vessel 130 of FIG. 1. In this respect, the vessel 330 is a ship-shaped vessel preferably having ice-breaking capabilities. However, it is understood that the vessel 330 may be of any shape. For example, a non-ship-shaped vessel such as an offshore working platform may utilize the water-agitating mechanism 320.

In the vessel 330 of FIG. 3, the water-agitating mechanism 320 comprises a plurality of pneumatic guns 322. The pneumatic guns 322 are suspended from cables 324. The cables 324, in turn, are supported by cable rods 326 extending laterally from the vessel 330. Alternatively, the pneumatic guns may be extended or towed behind the vessel 330. In any arrangement, the pneumatic guns 322 extend into the marine body 105.

The pneumatic guns 322 are preferably large-diameter, cylinder-shuttle air guns. Such guns have known uses in the context of seismic exploration. A specific exemplary air gun design is disclosed in U.S. Pat. No. 5,432,757, entitled “Large-Diameter, Cylinder-Shuttle Seismic Airgun Method, Apparatus and Towing System.” This patent is incorporated herein by reference in its entirety.

Using the pneumatic guns 322, powerful impulses of air may be released into the marine body 105. Of benefit, the impulses are readily repeatable at a desired frequency. In the present application, the air guns 322 may be fired to release powerful impulses on a cycle such as every two seconds (0.5 Hz), every five seconds (0.2 Hz), every ten seconds (0.1 Hz), or other frequencies.

In operation, air tubes (not shown) deliver air from an air canister or air pump on the vessel 330 to the air guns 322. The air is delivered to air chambers under pressure within the air guns 322. A trigger mechanism is used to actuate, or “fire,” the air guns 322. The trigger mechanism may be an electrically operated trigger valve, or solenoid valve. Upon firing, the pressurized gas is abruptly released from the air chambers and into the surrounding water medium, i.e., salt water.

The release of air from the plurality of air guns 322 is synchronized. In this way, wakes 132 and waves 135 are created. The waves 135 travel towards the ice mass 110 to cause ice fracture and break-up.

Another means for artificially generating waves 135 within the marine body 105 involves the use of large paddles. The paddles strike the surface of the marine body 105 and then stroke through the water.

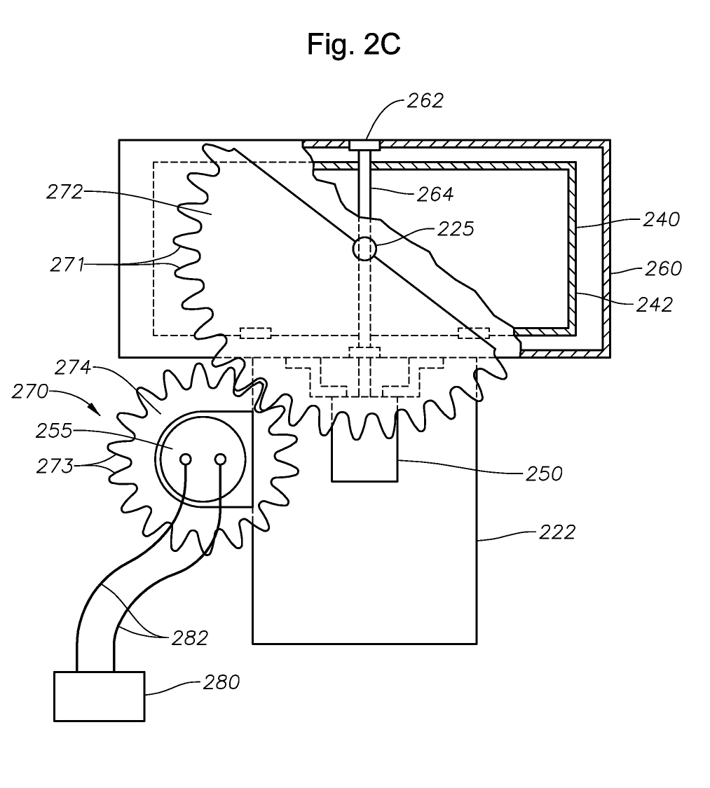

FIG. 4 is a cross-sectional view of an intervention vessel 430 using a water-agitating mechanism 420 in a third embodiment. The intervention vessel 430 includes a deck 410 and a hull 412. The vessel 430 is again representative of the intervention vessel 130 of FIG. 1. In this respect, the vessel 430 is a ship-shaped vessel preferably having ice-breaking capabilities. However, it is understood that the vessel 430 may be of any shape.

In the vessel 430 of FIG. 4, the water-agitating mechanism 420 comprises a plurality of paddles 422. The paddles 422 are supported by oars 424. The oars 424, in turn, are supported by a rotating shaft 426 that extends laterally from each side of the vessel 430.

In order to generate waves 135, the shaft 426 is rotated. Rotation may be clockwise, counter-clockwise, or intermittently clockwise and counter-clockwise. Rotation of the shaft 426 is driven by a motor assembly 440. The motor assembly 440 includes a motor 442. The motor 442 is supported by a stand or platform 446. The motor 442 imparts rotational movement to a drive shaft 444. The drive shaft 444 preferably extends from each end of the motor 442, though it may reside entirely within a housing of the motor 442.

The drive shaft 444 is connected to the rotating shaft 426. The rotating shaft 426 is supported within the hull 412 of the vessel 430 by support members 450. In the arrangement of FIG. 4, the support members 450 are connected to the inside of the hull 412. Opposing support members 450 are provided on either side of the motor 442.

Rotation of the drive shaft 444 causes the rotating shaft 426 to rotate. This, in turn, causes the paddles 422 to hit the surface of the marine body 105. The paddles 422 plunge through the water within the marine body 105 and then come back out for another cycle.

The frequency at which the paddles 422 strike the surface of the marine body 105 and then turn through the water is a function of the speed of the motor 442. Ideally, the paddles 420 strike the water in unison. The oars 424 and connected paddles 422 rotate at a frequency of about three to five seconds.

The oars 424 and connected paddles 422 are dimensioned to create waves 135 within the marine body 105. In one aspect, the oars 424 and connected paddles 422 are about 30 to 50 feet in length. The rotating shaft 426 ideally turns at a height that is about 15 feet above the surface of the marine body 105. This allows the paddles 422 to extend about 15 to 34 feet below the surface.

In the view of FIG. 4, only one rotating shaft 426 is shown and only one row of paddles 422 is seen. However, the operator may choose to have more than one motor 442 so that additional rotating shafts 426 with connected oars 424 and paddles 422 may be turned. The use of multiple rows of paddles 422 would increase the amplitude of the waves 135. This, in turn, would provide for more efficient breakage of the ice mass 110. In one embodiment, three rotating shafts 426 with connected oars 424 and paddles 422 are turned.

It is understood that the movement of the paddles 422 through the water will urge the intervention vessel 430 to move across the water. In some instances, this may actually be desirable as it enables the vessel 430 to move in response to movement of oil slicks. In this way, the vessel 430 may be repositioned for optimum effect. Alternatively, the vessel 430 may be moored to the bottom of the marine body 105 using anchors and catenary mooring lines (not shown). Alternatively, dynamic positioning using azimuthing propulusion motors may be employed to counter any translation of the vessel 430 across the marine body 105. Alternatively still, the operator of the vessel 430 may actively maintain station-keeping.

The use of azimuthing propulsion motors as suggested above may themselves create substantial artificial wave movement. This would be even without the paddles 422. Thus, another means proposed herein for artificially generating waves 135 within the marine body 105 involves the use of azimuthing propulsion motors.

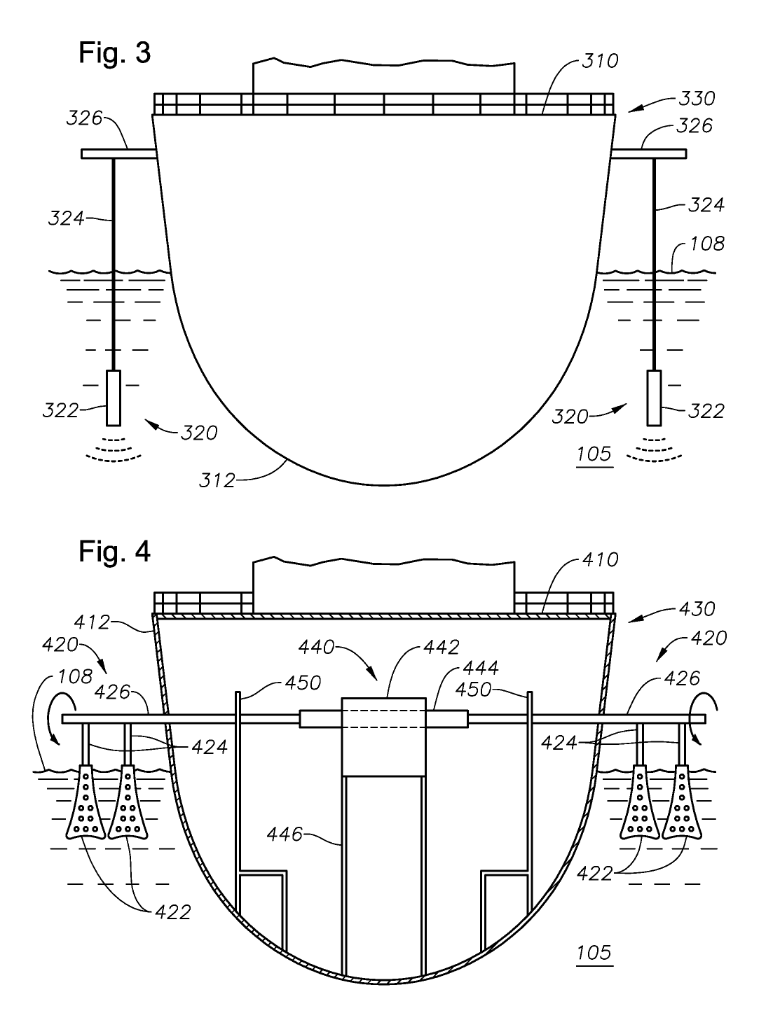

FIG. 5 is a cross-sectional view of an intervention vessel 530 having a water-agitating mechanism 520, in a fourth embodiment. The intervention vessel 530 includes a deck 510 and a hull 512. The vessel 530 is again representative of the intervention vessel 130 of FIG. 1. In this respect, the vessel 530 is a ship-shaped vessel preferably having ice-breaking capabilities. However, it is understood that the vessel 530 may be of any shape.

In the vessel 530 of FIG. 5, the water-agitating mechanism 520 comprises one or more pairs of propulsion motors 522. The propulsion motors 522 operate as azimuth thrusters. Azimuth thrusters are known as a means for propelling a large ship. Azimuth thrusters have also been used as part of dynamic positioning systems for station-keeping of floating offshore platforms.

Generally, an azimuth thruster is a configuration of ship propellers placed in pods. The pods are typically placed underneath a ship's hull or underneath a platform for a floating offshore structure. The pods and connected propellers can be rotated in any horizontal direction. This renders the use of a rudder for steering unnecessary. In the context of a large ship, azimuth thrusters give the ship much better maneuverability than a fixed propeller and rudder system. Further, ships with azimuth thrusters do not need tugs to dock, though they may still require tugs to maneuver in tight places.

In FIG. 5, a pair of azimuth thrusters 522 is shown. Each azimuth thruster 522 is supported by the hull 512 of the vessel 530. A support mounting is shown at 526 for each azimuth thruster 522. The support mountings 526 enable the azimuth thrusters 522 to rotate a full 360° relative to the vessel hull 512.

In the arrangement of FIG. 5, each azimuth thruster 522 has at least one propeller 524. The propeller 524 is generally used to move and maneuver the intervention vessel 530 through the marine body 105. However, upon arrival at the desired location between the hydrocarbon production platform 120 and the floating ice mass 110, the azimuth thrusters 522 are rotated so that the propellers 524 face and act against one another.

The opposing disposition of the azimuth thrusters 522 creates offsetting forces that tend to keep the vessel 530 on location, although some intermittent adjustments will be required. To the extent unmanageable drift of the vessel 530 might occur, anchors may be placed on the marine bottom, or the vessel 530 maintained on location through catenary mooring lines (not shown). Alternatively, a separate set of azimuth thrusters (not shown) may be provided for dedicated station-keeping.

The azimuth thrusters 522 and propellers 524 preferably operate through mechanical transmission. This means that a motor (not shown) resides inside the hull 512 of the vessel 530, with the motor being operatively connected to the propeller 524 by gearing. The motor may be diesel or diesel-electric.

In an alternative aspect, the azimuth thrusters 522 operate through electrical transmission. This means that an electric motor operates within the azimuth thruster 522 itself The electric motor is connected directly to the propeller 524 without gears. The electricity needed to drive the propellers 524 and to rotate the azimuth thrusters 522 is produced by an onboard engine, usually diesel or gas turbine.

In order to generate waves 135, and as shown in FIG. 5, a pair of azimuth thrusters 522 is positioned in opposing relation. Preferably, more than one pair of azimuth thrusters 522 is employed. Preferably, the propellers 524 are intermittently started and stopped in cycles to create waves 135 having well-defined peaks and troughs. In this respect, ice break-up is caused by the brittle ice being cantilevered over or spanning across wave troughs. This is in addition to the entrainment of air under the ice. The cycles may be, for example, every two to ten seconds or, more preferably, every four to eight seconds.

Another option offered herein for artificially generating waves 135 within the marine body 105 involves the use of subsurface plungers. The plungers strike the surface 108 of the marine body 105 and then stroke vertically down through the water and back up. Alternatively, the plungers vibrate or oscillate quickly in an up-and-down manner under the water.

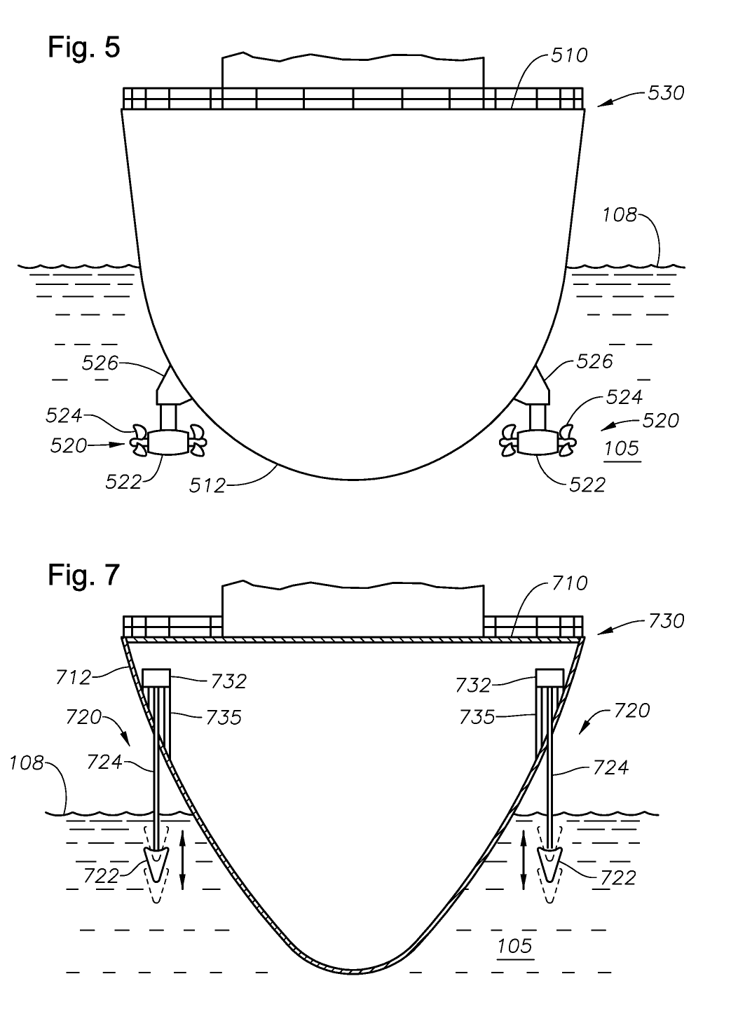

FIGS. 6A and 6B provide cross-sectional views of an intervention vessel 630 using a water-agitating mechanism 620, in a fifth embodiment. The intervention vessel 630 includes a deck 610 and a hull 612. The vessel 630 is again representative of the intervention vessel 130 of FIG. 1. In this respect, the vessel 630 is a ship-shaped vessel preferably having ice-breaking capabilities. However, it is understood that the vessel 630 may be of any shape or may define a floating platform.

In the vessel 630 of FIGS. 6A and 6B, the water-agitating mechanism 620 comprises a plurality of plungers 620. The plungers 622 are supported by vertical rods 624. Each rod 624, in turn, is supported by a reciprocating motor 632. The reciprocating motors 632 cause the rods 624 and connected plungers 622 to reciprocate vertically, that is, up-and-down within the water body 105.

In one aspect, the rods 624 are about 15 to 30 feet in length. In addition, the plungers 622 at the ends of the rods 624 are about 5 to 10 feet in length. Reciprocating motion of the rods 624 and connected plungers 624 creates wakes 132 and causes waves 135 to be propagated towards the ice masses 110. The rods 624 may move, for example, along a stroke that is five to 20 feet.

In FIG. 6A, the plungers 622 are in their raised position. This means the plungers 622 are at the respective tops of their strokes. In this position, the plungers 622 are about 5 to 17 feet above the surface 108 of the marine body 105. In response to movement of the vertical rods 624 by the reciprocating motor 632, the plungers 622 are rapidly lowered into the water. The plungers 622 strike the surface 108 of the marine body 105 and then stroke vertically down through the water.

In FIG. 6B, the plungers 622 are in their lowered position. This means that the plungers 622 are at the respective bottoms of their strokes. In this position, the plungers 622 are about 5 to 17 feet below the surface 108 of the marine body 105. In response to movement of the vertical rods 624 by the reciprocating motor 632, the plungers 622 are rapidly raised, and stroke vertically back up through the water.

In one embodiment, the plurality of plungers 622 reciprocate according to a stroke that is about 10 to 34 feet. The frequency of the strokes may be about every three to ten seconds (0.333 Hz to 0.1 Hz). In this instance, the top of the stroke is at or above the surface of the body of water, and the bottom of the stroke is below the surface of the body of water.

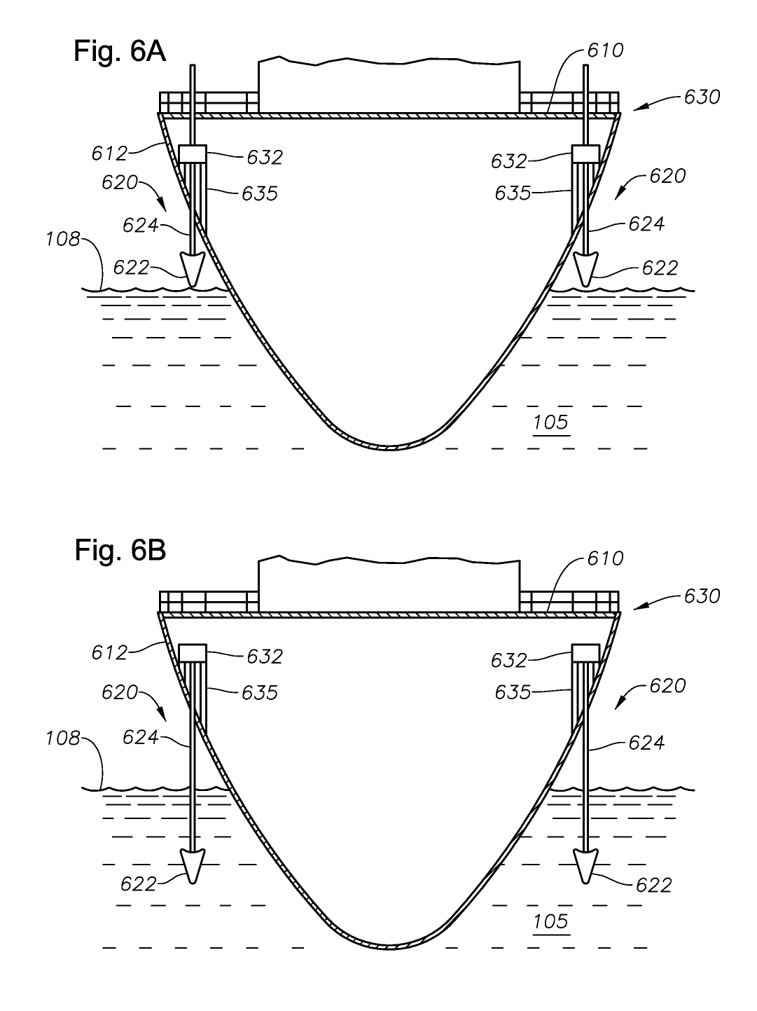

A final and related method for creating artificially-generated waves also involves the use of a plunger. FIG. 7 is a cross-sectional view of a vessel 730 having a water-agitating mechanism 720, in a sixth embodiment. Here, the water-agitating mechanism 720 is again a plunger 722.

The plungers 722 are supported by vertical rods 724. Each rod 724, in turn, is supported by a reciprocating motor 732. The reciprocating motors 732 cause the rods 724 and connected plungers 722 to reciprocate. Reciprocation may be vertical, that is, up-and-down, within the water body 105. Alternatively, reciprocation may be lateral or in a circular pattern.

In one aspect, the rods 724 are about 10 to 20 feet in length. In addition, the plungers 722 at the ends of the rods 724 are about 5 to 10 feet in length. Reciprocating motion of the rods 724 and connected plungers 722 creates wakes 132 and causes waves 135 to be propagated towards the ice masses 110. It is preferred that the plurality of plungers 722 reciprocate substantially simultaneously.

It is noted that the plungers 722 may alternatively be shaped as paddles, such as paddles 422 of the water-agitating mechanism 420 in FIG. 4. In this arrangement, reciprocation or vibration by the motors 732 would create more of a lateral movement than a vertical movement. In either instance, the reciprocating motors 732 provide short, fast strokes to vibrate a device under the water.

In the embodiment of FIG. 7, the plurality of plungers 722 may reciprocate according to a stroke that is about 1 to 5 feet. The frequency of the strokes may be about 0.1 to 2.0 seconds (10.0 Hz to 0.5 Hz). In this instance, both the top and the bottom of each stroke is below the surface 108 of the body of water 105.

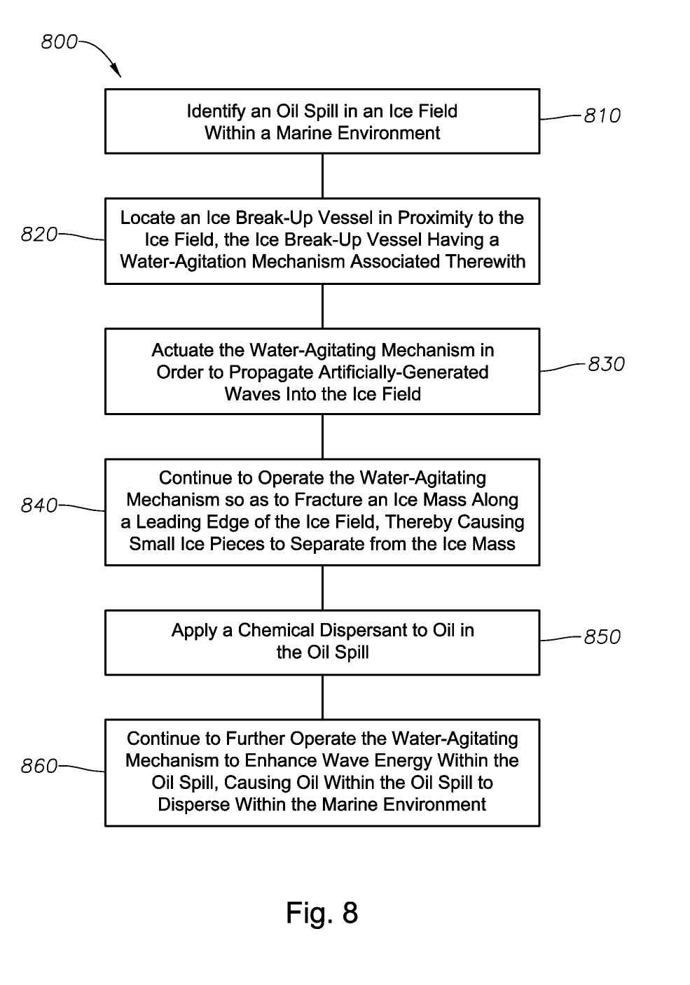

FIG. 8 is a flowchart showing steps for a method 800 for dispersing oil from an oil spill in a marine environment, in one embodiment. In the method 800, the marine environment comprises a body of water, and a surface of the body of water. The marine environment may be, for example, a bay, a sea or an ocean in the Arctic region of the earth.

The marine environment also has an ice field. At least one floating ice mass resides within the ice field. The ice mass floats on the surface of the body of water.

The method 800 includes the step of identifying an oil spill in proximity to the at least one ice mass. This step is shown at Box 810. The oil spill may have been caused in connection with drilling activities in the ice field. Alternatively, the oil spill may have been caused in connection with production activities or fluid separation processes in or up-current from the ice field. Alternatively still, the oil spill may have been caused from hydrocarbon transportation activities, either from a leak or rupture in a flow line or other piping, or from a leak or rupture in the hull or holding tank or piping on a vessel. The present inventions are not limited by the source or nature of the oil spill unless so indicated in a claim.

The method further includes the step of locating an intervention vessel in proximity to the ice field. This is indicated at Box 820. The intervention vessel may be, for example, a ship-shaped vessel having a deck and a hull. Preferably, the intervention vessel is equipped with ice-breaking capability. As an alternative, the intervention vessel may be a non-ship-shaped platform. The platform is preferably a floating platform. The intervention vessel may optionally be maintained at its location by a dynamic positioning system, by mooring, or by operator seamanship. Alternatively, the vessel is periodically repositioned or re-stationed to optimize access to floating oil.

The intervention vessel also has a water agitating mechanism associated therewith. The method then further comprises actuating the water-agitating mechanism. This is indicated at Box 830. Actuating the water-agitating mechanism causes artificially-generated waves to be propagated through the marine body. The waves travel towards a leading edge of the ice mass. In one aspect, the artificially generated waves have an amplitude of about two feet to five feet.

Various types of water-agitating mechanisms may be employed, as discussed above. For example, the water-agitating mechanism may comprise a gyroscopic system attached to the hull of the intervention vessel. The gyroscopic system may comprise a large spinning mass, a controller, and at least one gear for moving the large spinning mass so as to cause forced precession. The controller causes the large spinning mass to reciprocate according to a specified frequency and amplitude. The large spinning mass is reciprocated in a direction to cause the intervention vessel to pitch, to roll, or combinations thereof.

In another embodiment, the water-agitating mechanism comprises a plurality of air guns. The air guns are disposed below the surface of the marine environment in the body of water. The plurality of air guns may be fired substantially simultaneously at a frequency of about two seconds to five seconds (0.5 Hz to 0.2 Hz).

In another embodiment, the water-agitating mechanism comprises a plurality of paddles. The paddles rotate through the surface of the marine environment and into the body of water. The plurality of paddles may rotate substantially simultaneously at a frequency of about three to five seconds (0.33 Hz to 0.2 Hz).

In another embodiment, the water-agitating mechanism comprises at least one pair of offsetting propulsion motors. The propulsion motors operate below the surface of the marine environment and in the body of water. In one aspect, the at least one pair of offsetting propulsion motors are intermittently started and stopped in cycles to create waves having well-defined peaks and troughs. The cycles may be, for example, every two to ten seconds (0.5 Hz to 0.1 Hz).

In another embodiment, the water-agitating mechanism comprises a plurality of plungers that reciprocate vertically in the body of water. In one aspect, the plurality of plungers reciprocate substantially simultaneously.

In one arrangement, the plurality of plungers may reciprocate according to a stroke that is about 10 to 34 feet. In this instance, the frequency of the strokes may be about every three to ten seconds (0.33 Hz to 0.1 Hz). Here, the top of the stroke is at or above the surface of the body of water, while the bottom of the stroke is below the surface of the body of water.

In another arrangement, the plurality of plungers may reciprocate according to a stroke that is about 1 to 5 feet. This is a much shorter stroke such that the plunger is in the nature of a resonance vibrator. In this instance, the frequency of the strokes is about 0.1 to 2.0 seconds (10.0 Hz to 0.5 Hz). Here, both the top and the bottom of each stroke is below the surface of the body of water. The strokes may be vertical or lateral.

The method 800 for dispersing oil from an oil spill in a marine environment also includes continuing to operate the water-agitating mechanism. This is provided at Box 840. Continuing to operate the water-agitating mechanism causes the ice mass to be at least partially fractured into small ice pieces. The ice mass is primarily fractured along a leading edge, but long fractures may also occur within the body of the ice mass.

The small ice pieces separate from the ice mass. The small ice pieces then float in the marine environment where they may continue to break into yet smaller ice pieces.

The method 800 further includes applying a chemical dispersant to the oil spill. This step is shown at Box 850. The chemical dispersant is a liquid dispersant having an operative surfactant. The surfactant transfers into the oil slick and locates at the oil-water interface. The surfactant reduces the interfacial tension between the hydrocarbon molecules and the water. The reduced interfacial tension allows the oil slick or oil spill to more readily disperse into the marine body when it encounters mixing energy in the form of waves.

It is noted that the chemical dispersant may be applied to any exposed oil. Exposed oil primarily means oil slicks floating on the water. However, in the present applications exposed oil will also mean oil residing on the top surfaces of floating ice pieces or near the edge of floating ice masses. The step of Box 820 may be carried out as soon as an oil spill is identified under Box 810, after the water-agitating mechanism has been activated per Box 830, after the water-agitating mechanism has begun fracturing the ice mass under Box 840, or combinations thereof.

FIGS. 9A through 9C present illustrative steps for the dispersion of oil into water using a chemical dispersant. In each figure, a pool of oil, or “oil slick” 910, is seen floating on the surface 108 of a body of water, or marine body 105. The oil slick 910 may be representative of oil slick 106 from FIG. 1B.

In FIG. 9A, a liquid chemical dispersant 920 is being applied to the oil slick 910. The dispersant 920 is shown in the form of discrete droplets. The droplets have, for example, a diameter of 0.4 to 0.7 micrometers.

In FIG. 9B, the dispersant 920 transfers into the oil slick 910 and releases individual surfactant molecules 922. The surfactant molecules 922 then locate at the interface between the oil slick 910 and air 905, and further locate at the interface between the oil slick 910 and the surface of the water 108.

In FIG. 9C, the oil slick 910 is beginning to break up into droplets 912. This is in response to the action of the surfactant droplets 922, which are attached to the oil droplets 912. It can be seen in FIG. 9C that the oil droplets 912 are dispersing into the body of water 105. Action of the artificially-generated waves 135 substantially aids this dispersion process. Current shear also aids in the dispersion process.

Referring to the flowchart of FIG. 8, the method 800 also includes continuing to further operate the water-agitating mechanism. This is for the purpose of enhancing wave energy within the oil spill. This is indicated at Box 870. The wave action aids the dispersion of oil in the marine body as shown in FIG. 9C.

While it will be apparent that the inventions herein described are well calculated to achieve the benefits and advantages set forth above, it will be appreciated that the inventions are susceptible to modification, variation and change without departing from the spirit thereof. For example, the methods and water-agitating mechanisms disclosed herein have utility for clearing ice from a hydrocarbon operations platform.

What is claimed is:

1. A method for dispersing oil from an oil spill in a marine environment, the marine environment having at least one floating ice mass within an ice field, the method comprising:
identifying an oil spill in the ice field;
locating an intervention vessel in proximity to the ice field, the intervention vessel having a water-agitating mechanism associated therewith;
actuating the water-agitating mechanism while the intervention vessel is in a substantially stationary location in order to propagate artificially-generated waves into the ice field;
continuing to operate the water-agitating mechanism so as to fracture the at least one floating ice mass into smaller ice pieces;
applying a chemical dispersant to the oil spill; and
continuing to further operate the water-agitating mechanism to enhance wave energy within the oil spill, thereby causing oil within the oil spill to disperse within the marine environment.

2. The method of claim 1, wherein:
the marine environment comprises a body of water, and a surface of the body of water; and
the marine environment is a bay, a sea or an ocean in the Arctic region of the earth.

3. The method of claim 2, wherein the intervention vessel is maintained at its location by dynamic positioning system, by mooring, or by steering by a vessel operator.

4. The method of claim 2, further comprising:
relocating the intervention vessel in response to movement of the oil spill.

5. The method of claim 2, wherein the artificially generated waves produce an amplitude of about two feet to five feet.

6. The method of claim 2, wherein:
the intervention vessel is a ship-shaped vessel having a deck and a hull; and
the water-agitating mechanism is a gyroscopic system attached to the hull of the intervention vessel.

7. The method of claim 6, wherein:
the gyroscopic system comprises a large spinning mass, a controller, and at least one gear for moving the large spinning mass so as to cause forced precession; and
the controller sends a signal to the at least one gear to reciprocate the large spinning mass according to a specified frequency and amplitude.

8. The method of claim 7, wherein:
the large spinning mass is reciprocated in a direction to cause the intervention vessel to pitch, to roll, or combinations thereof.

9. The method of claim 2, wherein the water-agitating mechanism comprises a plurality of air guns disposed below the surface of the marine environment in the body of water.

10. The method of claim 9, wherein the plurality of air guns are fired substantially simultaneously at a frequency of about two seconds to five seconds (0.5 Hz to 0.2 Hz).

11. The method of claim 2, wherein the water-agitating mechanism comprises a plurality of paddles that rotate through the surface of the marine environment and into the body of water.

12. The method of claim 11, wherein the plurality of paddles rotates substantially simultaneously at a frequency of about three to five seconds (0.33 Hz to 0.2 Hz).

13. The method of claim 2, wherein the water-agitating mechanism comprises at least one pair of offsetting propulsion motors that operate below the surface of the marine environment and in the body of water.

14. The method of claim 13, wherein:
the at least one pair of offsetting propulsion motors are intermittently started and stopped in cycles to create waves having well-defined peaks and troughs; and
the cycles are every two to ten seconds (0.5 Hz to 0.1 Hz).

15. The method of claim 2, wherein the water-agitating mechanism comprises a plurality of plungers that reciprocate in the body of water.

16. The method of claim 15, wherein the plurality of plungers reciprocate substantially simultaneously.

17. The method of claim 15, wherein:
the plurality of plungers reciprocate vertically according to a stroke that is about 5 to 20 feet;
the frequency of the strokes is about every three to ten seconds (0.33 Hz to 0.1 Hz);
the top of the stroke is at or above the surface of the body of water; and
the bottom of the stroke is below the surface of the body of water.

18. The method of claim 15, wherein:
the plurality of plungers reciprocate according to a stroke that is about 1 to 5 feet;
the frequency of the strokes is about 0.1 to 2.0 seconds (10.0 Hz to 0.5 Hz); and
both the top and the bottom of each stroke is below the surface of the body of water.

19. The method of claim 18, wherein the plungers reciprocate vertically or laterally.

20. The method of claim 1, wherein:
the at least one floating ice mass comprises a plurality of ice masses separated by leads;
the oil spill is at least partially located in the leads; and
applying a chemical dispersant to the oil spill comprises applying the chemical dispersant to oil located in the leads.

21. The method of claim 1, wherein:
the oil spill is at least partially located below the at least one floating ice mass and along the surface of the body of water;
fracturing the at least one floating ice mass into smaller ice pieces at least partially exposes oil in the oil spill; and
applying a chemical dispersant to the oil spill comprises applying the chemical dispersant to the exposed oil.

22. The method of claim 1, wherein:
the oil spill is at least partially located on a surface of the at least one floating ice mass;
fracturing the at least one floating ice mass into smaller ice pieces at least partially breaks up the oil spill onto the smaller ice pieces; and
applying a chemical dispersant to the oil spill comprises applying the chemical dispersant to the oil on the smaller ice pieces.

23. The method of claim 2, wherein:
the oil spill is at least partially located on the surface of the body of water; and
the chemical dispersant is at least partially applied to the oil spill before the water-agitating mechanism is actuated.
